(19) United States
(12) Patent Application Publication
(10) Pub. No.: US 2012/0260937 A1
(43) Pub. Date: Oct. 18, 2012

(54) METHOD AND DEVICE FOR CLEANING A SURFACE

(75) Inventors: Wolfgang Glaentz, Schweinfurt (DE); Tilmann Haar, Hassfurt (DE); Steffen Hain, Karlstadt (DE); Andreas Kern-Trautmann, Estenfeld (DE); Jochen Lorenscheit, Rimpar (DE); Ingo Schulz, Gerolzhofen (DE); Roland Worsley, Langenfield (DE)

(73) Assignee: AKTIEBOLAGET SKF, Goteborg (SE)

(21) Appl. No.: 13/443,528

(22) Filed: Apr. 10, 2012

(30) Foreign Application Priority Data
Apr. 15, 2011 (DE) 10 2011 007 472.4

(51) Int. Cl. B08B 7/00; B08B 13/00

(52) U.S. Cl. 134/1; 156/345.45

(57) ABSTRACT

A device for cleaning a surface of a component includes a high voltage source having a cathode configured to be electrically connected with the surface of the component. An ionization electrode includes at least one individual electrode configured to be electrically connected with an anode of the high voltage source. A movable carriage moves the ionization electrode relative to the surface of the component so that an electric field generated between the ionization electrode and the surface of the component is also moved relative to the surface of the component.

### CROSS-REFERENCE

This application claims priority to German patent application no. 10 2011 007 472.4 filed on Apr. 15, 2011, the contents of which are fully incorporated herein by reference.

### TECHNICAL FIELD

The present invention relates to methods and devices for cleaning a surface of a component, e.g. using an ion wind.

### BACKGROUND

A variety of methods for cleaning the surface(s) of components are known. For example, in contact methods, a cleaning brush or the like directly and physically contacts the surface. In non-contact methods, contaminants may be suctioned from or blown off of the surface.

Most non-contact methods have the advantage that the risk of damaging a surface during cleaning is quite low. However, known suctioning or blowing methods require a relatively high expenditure for the equipment necessary to generate a sufficient flow velocity to achieve the required air volumes, e.g., using an external fan, and to convey the air flow it to/from the surface to be cleaned. Also, when suctioning or blowing techniques are used, a constant or uniform cleaning performance across the entire surface of a curved or irregularly-shaped component can be achieved only if the suction nozzle or pressurized air nozzle is guided at a predetermined distance to the surface along the contour of the component, which is often a mechanically complex undertaking.

### SUMMARY

It is an object of the present teachings to provide more efficient cleaning techniques.

In one aspect of the present teachings, a surface of a component may be cleaned using an electrostatically-generated particle stream, e.g., a stream of ionized particles (hereinbelow, an “ion wind”). For this purpose, a device for cleaning a surface of a component preferably comprises an ionization electrode connected to an anode of a high voltage source. The device also preferably comprises a coupling device configured to electrically connect a cathode of the high voltage source with the surface of the component to be cleaned. At least the surface of the component is preferably electrically conductive. In this case, once the cathode is electrically connected with the surface of the component and the high voltage source is energized (turned on), ions (ionized or charged atoms and/or molecules) will be generated in the vicinity of the ionization electrode and then accelerated along the field lines of at least one electric field, which extends from the anode or the ionization electrode towards the surface of the component.

Upon impacting the surface, the ions, i.e. ionized gas or air molecules or atoms, typically discharge and experience a momentum transfer, so that they move or bounce away from the surface to be cleaned as neutral particles. If fine debris or liquid contaminants are disposed on the surface of the component to be cleaned, e.g., oil, dust or the like, and the accelerated particles of the ion wind impact or forcibly strike the contaminating particles adhered to or located on the surface, such contaminating particles will be dislodged from the surface by the momentum transfer from the ions to the contaminating particles. As a result, the contaminating particles are loosened and removed from the surface of the component due to the energy of the ion particles striking the contaminating particles.

In certain embodiments of the present teachings, it is possible to achieve effective cleaning using a relative simple arrangement of an ionization electrode disposed on one of the opposing sides of the surface to be cleaned without having to provide expensive external devices or blowers. Furthermore, this type of cleaning can be more efficient with respect to microscopic particles than the above-mentioned known non-contact methods.

In another aspect of the present teachings, a device for cleaning a surface may comprise a moving device, e.g., a movable carriage or carrier, configured to move the ionization electrode and/or the surface of the component in at least one movement direction relative to one another. For example, the ionization electrode can be moved along the movement direction relative to the surface of the component or vice versa. As a result of this movement, the cleaning takes place not only locally but also continues along the movement direction. Therefore, the entire surface of a component can be cleaned by causing the ionization electrode to pass over or traverse the surface in one or more cleaning steps, e.g., one pass, two passes, etc.

In another aspect of the present teachings, the ionization electrode preferably has a geometric shape such that, for example, it generates the ions itself through a point effect in a vicinity of the electrode or in an ionization volume that forms around the ionization electrode. This can be achieved by field ionization if the electrode is shaped in a pointed enough manner or if it comprises a sufficient number of tapered areas, so that the minimum electric field strength required for ionization is exceeded in the vicinity of the electrode.

In some exemplary embodiments of the present teachings, it is advantageous to generate an inhomogeneous field by appropriately arranging the ionization electrode(s) and the opposing cathode(s), i.e. the surface to be cleaned.

In addition or in the alternative, it is preferable that the zone or extent of the field ionization does not extend all the way to the surface of the component. That is, the field ionization surrounds the ionization electrode (e.g., a tip or point thereof) and preferably ends at a location spaced from the surface of the component to be cleaned.

In another aspect of the present teachings, an attachment device may be configured to hold or guide the component to be cleaned, so that the ionization electrode(s) point(s) towards the surface to be cleaned.

In another aspect of the present teachings, the ionization electrode is not a single electrode, but rather comprises a plurality of individual electrodes disposed in the form of an array, either linear (1-dimensional) or 2-dimensional. Such an array may extend, for example, along a direction perpendicular to the movement direction, so that the largest possible area may be cleaned using one movement (swipe) in the movement direction, which essentially corresponds to the extension of the array of the individual electrodes.

In order to further increase the cleaning effect or performance, a plurality of electrode arrays may be disposed one behind the other, i.e. parallel to one another and one behind the other or next to each other, relative to the movement direction. That is, the cleaning device may include two or more parallel rows of ionization electrodes that are each configured to cover the same area to be cleaned when the cleaning device moves relative to the surface to be cleaned. For example, the ionization electrodes may be disposed in the form of a 2-dimensional grid. The rows and columns may be either aligned or offset in one or both of the X and/or Y directions of the grid.

In another aspect of the present teachings, the high voltage source is configured to generate and apply a voltage in the range from 1 kV to 100 kV, more preferably between 3 kV and 12 kV, across the ionization electrode(s) and the surface to be cleaned. The high voltage is preferably sufficient to both generate a sufficient quantity of ionized particles for cleaning purposes and to sufficiently accelerate them so that they can impart a sufficient momentum transfer to the contaminating particles to be removed from the surface.

In another aspect of the present teachings, the amount of voltage actually applied during the cleaning process is monitored and fed back to a control circuit for adjustment (increase or decrease) of the amount of applied voltage. In this case, if the distance between the ionization electrode(s) and the surface of the component varies, the varying distance can be compensated by increasing or decreasing the voltage between the ionization electrode(s) and the surface of the component, so that the cleaning effect can be maintained unchanged, even if the surface of the component is uneven or curved. This can be achieved through simple readjustment of the voltage, without having to operate a complex mechanism to mechanically readjust a holder for the electrode relative to the surface.

In certain embodiments of the present teachings, it is possible to utilize corona charging by appropriately selecting the ionization electrode(s) and the voltage. In order to generate ionized particles by corona charging or discharging, conductive electrode tip(s) is (are) supplied with high voltage to generate ions in the immediate vicinity of the tip(s) though corona charging and field ionization, e.g. air ions are generated. These ions are then accelerated along the electric field lines towards the component and generate an ion wind between the ionization electrode and the component. This ion wind also acts as a barrier for particles moving between the ionization electrode and the surface, so that once removed, contaminating particles can no longer re-enter the air volume that being swept by the electric field.

Instead of a one-dimensional electrode array, in some exemplary embodiments a (thin) electrode lip can also be used, in order to generate an inhomogeneous electric field and create a corona charging in the air molecules surrounding the electrode lip.

The present cleaning methods may be performed in an air environment at or about atmospheric pressure. However, the present cleaning methods may also be performed in a sub-atmospheric pressure environment (i.e. a partial vacuum) and/or in a specialized gaseous environment, such as e.g., nitrogen, argon, etc.

Further objects, embodiments, advantages and designs will be explained in the following with the assistance of the exemplary embodiments and the appended Figures.

### BRIEF DESCRIPTION OF THE DRAWINGS

FIG. 1 shows a schematic sectional view through an exemplary embodiment of a device for cleaning a surface.

FIG. 2 shows a schematic perspective view of another exemplary embodiment of a device for cleaning a surface.

FIG. 3 shows a schematic perspective view of an exemplary embodiment of an ionization electrode for use in one of the exemplary embodiments of FIG. 1 or 2.

FIG. 4 shows a schematic diagram of another exemplary embodiment of an ionization electrode for use in one of the exemplary embodiments of FIGS. 1 to 3.

FIG. 5 shows a flow chart of an exemplary embodiment of a method for cleaning a surface of a component.

### DETAILED DESCRIPTION OF THE INVENTION

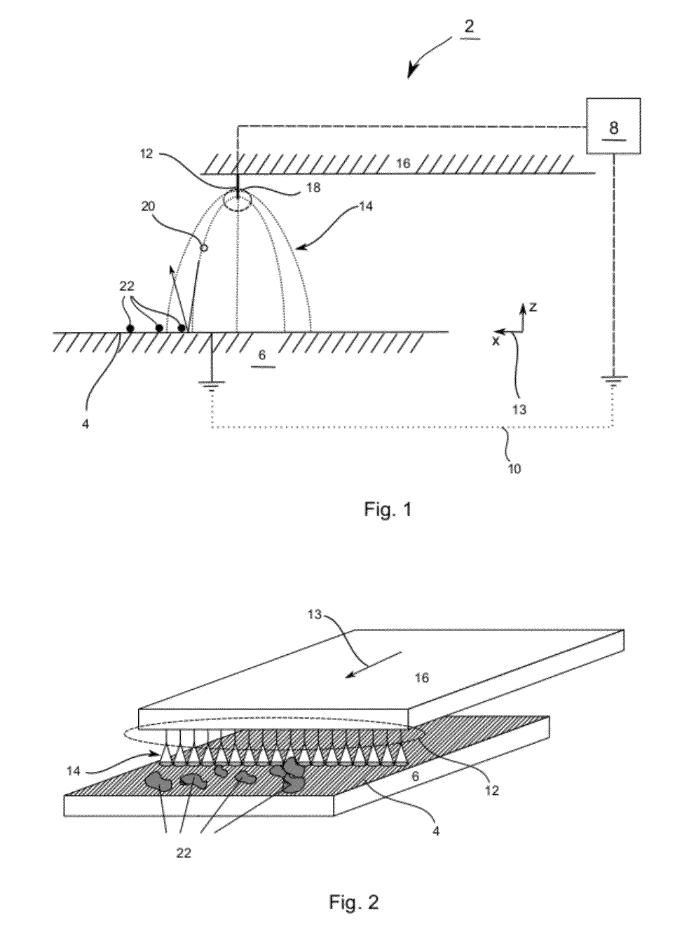

FIG. 1 shows a schematic side view of a representative device 2 for cleaning a surface 4 of a component 6. A cathode of a high voltage source 8 is connected via a coupling apparatus 10, which is only schematically represented herein, with the surface 4 of the component 6.

The coupling apparatus 10 can comprise, e.g., one or more of a clip or a wire or a plug/socket, and serves to electrically connect the cathode of the high voltage source 8 to the surface 4, which is electrically conductive. In general, the term “coupling apparatus” should be understood to cover any type of physical structure or element that enables the cathode to be electrically connected with the surface 4 and the present teachings are not particularly limited in this regard.

An ionization electrode 12, which is in the form of an individual electrode in the present embodiment, is connected with the anode of the high voltage source 8.

The ionization electrode 12 is movable relative to the surface 4 of the component 6 in at least one movement direction 13. In the present embodiment, the ionization electrode 12 is movable in the X-direction shown in FIG. 1, so that an electric field 14 generated between the ionization electrode 12 and the surface 4 of the component 6 is also moved in the X-direction. Furthermore, the ionization electrode 12 is disposed on a movable carriage 16, so that the surface 4 is held in a stationary manner and the ionization electrode 12 is moved relative to the surface 4. Of course, in an alternative exemplary embodiment, this arrangement could be reversed such that the ionization electrode(s) 12 is held stationary and the surface 4 is moved relative thereto. Naturally, it is also possible for both the ionization electrode(s) 12 and the surface 4 to be moved at the same time and relative to each other.

Moreover, the path of the relative movement need not be flat or level (i.e. substantially one-directionally). Instead, all possible paths of movements and geometries are possible, e.g., curved, stepped, oblique, etc. For example, in some exemplary embodiments, the component 6 may be cylindrical and its surface 4 may be rotated relative to a stationary ionization electrode 12.

By suitably shaping the ionization electrode 12 and selecting an appropriate high voltage based upon the conductive properties of the surface 4 and the gap in the Z-direction between the ionization electrode 12 and the surface 4, a corona charge or discharge of the gaseous medium, e.g. air, surrounding the ionization electrode 12 results in the vicinity 18 of the ionization electrode 12.

Rod electrodes or electrodes tapered to a point, i.e. thin, are especially suitable as ionization electrode 12, so that the dielectric breakdown field strength necessary for air ionization can be exceeded at the point of the ionization electrode 12, which will lead to the corona charging of the air atoms and molecules in the vicinity of the ionization electrode 12.

Using other terminology, when the electric field strength exceeds the corona discharge inception gradient of the ambient environment, ionization of nearby gas molecules or atoms will take place. Since the ionized gas molecules will have the same polarity as the tip or point where ionization is taking place, the ionized gas molecules or items will be accelerated away from the ionization electrode due to the repulsion between the ions and ionization electrode. This repulsion of ions creates an electric or ion “wind” emanating from the tip or point of the ionization electrode. The ion wind travels along the electric field line(s) 14 towards the surface 4. Thus, when the ionized particles in the ion wind strike the contaminating particles 22 on the surface 4, the contaminating particles 22 are dislodged and blown off of the surface 4.

In some exemplary embodiments, the movement between the ionization electrode 12 and the surface 4 occurs at such a distance, or the voltage is chosen, so that the vicinity 18 in which the corona charging takes place does not extend to the surface 4. That is, the range or zone of corona charging/discharging does not encompass the surface 4.

The ion wind generated as a result of the corona charging also creates a barrier between the ionization electrode 12 and the surface 4 that prevents the dislodged particles from re-entering the volume of the ionized particles, thereby preventing recontamination of the surface 4 after it has been cleaned.

Furthermore, either electric charges from the ionized air molecules are transferred to other particles that are to be removed, which are first accelerated towards surface 4 and then accelerated away from it, or an elastic impact occurs between the ionized air molecules and the particles that are to be removed. In either case, the particles to be removed are accelerated away from the gap between the ionization electrode 12 and the surface 4.

The ion wind leads to the cleaning of the surface 4, as ions 20 accelerated along the field lines 14 strike contaminating particles 22 on the surface 4 and removed them due to the impact, as is schematically indicated in FIG. 1.

The high voltage source 8 is preferably configured to generate a sufficiently large electric field around the ionization electrode 12, so that corona charging of the gaseous medium can result in the vicinity of the ionization electrode 12, and so that a sufficiently strong ion wind results between the ionization electrode 12 and the surface 4. The high voltage source 8 can at the same time be configured for example—depending on the vicinity and distance between ionization electrode 12 and the surface 4—to generate high voltages in the range from 1 kV to 100 kV, but more preferably in the range of 3 kV to 12 kV.

As a result, the entire surface 4 can be cleaned in one or more successive passes across the surface 4 by moving the ionization electrode 12 relative to the surface 4.

FIG. 2 shows a further exemplary embodiment of the present teachings, wherein the ionization electrode 12 comprises a linear electrode array that extends substantially perpendicular to the movement direction 13. Therefore, a relatively wide area of the surface 4 can be cleaned simultaneously, as long as a continuous electric field is generated by the individual electrodes along the linear extension of the electrode array 12. This continuous electric field need not be homogeneous, as was described above.

This embodiment can further increase the efficiency of the cleaning with the same control circuitry expenditure, so that, depending on the dimension of the electrodes, it is possible that only a single movement (pass or swipe) in the movement direction 13 is required to clean the entire surface 4 of the component 6.

In further exemplary embodiments, a plurality of electrode arrays, of which one example is represented in FIG. 2, can be used as ionization electrode 12. The plurality of electrode arrays can be disposed parallel to one another and one behind the other in the movement direction 13, i.e. adjacent to each other. This arrangement can further increase the cleaning performance, wherein again there is no additional control circuitry expense.

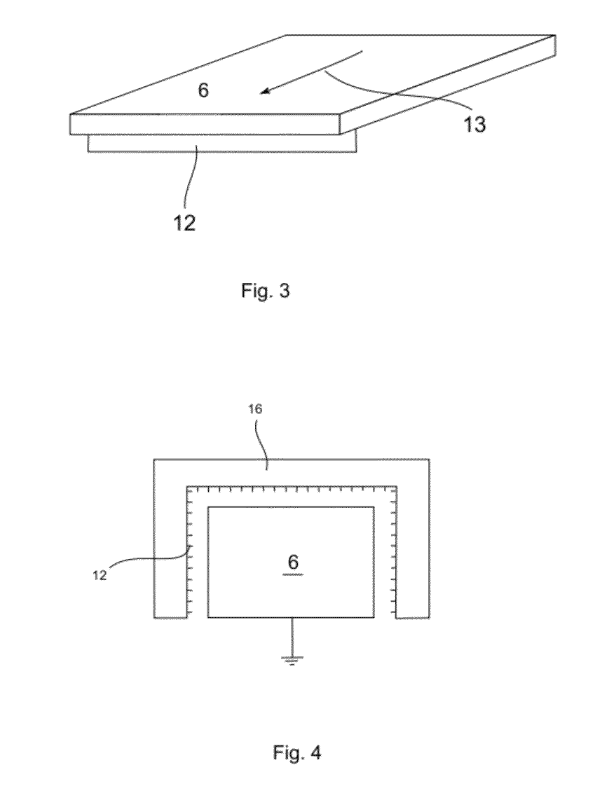

FIG. 3 shows an alternative embodiment of an ionization electrode 12 which, as shown in FIG. 4, can be formed, e.g., as 2-dimensional continuous lips, i.e. as continuous electrodes extending in the direction of the surface 4. Of course any other types of electrode geometries are also usable with the present teachings.

The alternative embodiment of FIG. 4 illustrates the design flexibility of devices for cleaning surfaces according to the present teachings. In this embodiment, three surfaces of a rectangular-shaped component 6 can be cleaned simultaneously. For this purpose, a single electrode array made from a plurality of individual electrodes 12 is disposed on a carriage 16, which encloses the component 6 in a U-shaped manner. Therefore, the entire surface of the component 6 can be cleaned by a single movement or swipe in the movement direction.

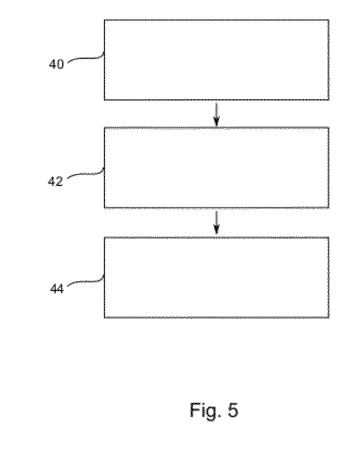

FIG. 5 schematically illustrates an exemplary embodiment of a method for cleaning the surface of a component.

In preparation step 40, the surface of the component is first disposed opposite one or more ionization electrode(s). The component and ionization electrode(s) are preferably disposed in a gaseous medium, e.g., air at atmospheric pressure.

In electric field generating step 42, a high voltage is applied between the ionization electrode and the surface of the component, so that an electric field forms between the ionization electrode and the surface of the component. This electric field accelerates ions (ionized air particles), produced by the ionization electrode, towards the surface of the component.

In cleaning step 44, the ionization electrode and the surface are moved relative to each other in a movement direction, in order to clean the surface of the component along the movement direction.

Although described here predominately by utilizing relatively simple geometries, it should be understood that the above-described concept for cleaning surfaces can be easily modified to clean surfaces of any shape without requiring expensive mechanical tracking systems for suction nozzles or the like.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved cleaning methods, cleaning devices and methods for manufacturing and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

2 device for cleaning a surface
4 surface
6 component
8 high voltage source
10 coupling apparatus
12 ionization electrode
13 movement direction
14 electric field
16 movable carriage
18 vicinity
20 ion
22 contaminating particle
40 preparation step
42 field generating step
44 cleaning step

1. A device for cleaning a surface of a component comprising:
a high voltage source having a cathode configured to be electrically connected with the surface of the component;
an ionization electrode comprising at least one individual electrode configured to be electrically connected with an anode of the high voltage source; and
a movable carriage configured to move at least one of the ionization electrode and the surface of the component in at least one movement direction relative to the other such that an electric field formed between ionization electrode and the surface of the component is also moved relative to the surface of the component.

2. The device according to claim 1, wherein the ionization electrode is configured to generate an inhomogeneous electric field between the ionization electrode and the surface of the component.

3. The device according to claim 1, further comprising:
an attachment device configured to hold the component such that a gap of predetermined dimension is formed between the surface of the component and the ionization electrode.

4. The device according to claim 1, wherein the at least one individual electrode has a shape that tapers towards the surface of the component.

5. The device according to claim 1, wherein the at least one individual electrode has a shape of a cone, a truncated cone or a point.

6. The device according to claim 1, wherein the ionization electrode comprises an array of individual electrodes, the array extending at least substantially perpendicular to the movement direction and the array being configured to generate a continuous electric field along its extension between the array and the surface of the component.

7. The device according to claim 6, wherein the ionization electrode comprises a plurality of linear arrays of individual electrodes that are adjacent to each other in the movement direction.

8. The device according to claim 1, wherein the high voltage source is configured to generate a voltage in a range from 1 kV to 100 kV.

9. The device according to claim 1, wherein the high voltage source is configured to generate a voltage in a range from 3 kV to 12 kV.

10. The device according to claim 9, wherein the ionization electrode comprises a linear array of individual electrodes, the linear array extending at least substantially perpendicular to the movement direction and the array being configured to generate a continuous electric field along its extension between the array and the surface of the component.

11. The device according to claim 10, wherein the individual electrodes each have a shape that tapers towards the surface of the component.

12. The device according to claim 10, wherein the individual electrodes each have a shape of a cone, a truncated cone or a point.

13. The device according to claim 12, wherein the ionization electrodes are configured to generate an inhomogeneous electric field between the ionization electrodes and the surface of the component.

14. The device according to claim 13, wherein the ionization electrodes further comprise a plurality of linear arrays of individual electrodes that are adjacent to each other in the movement direction.

15. A method for cleaning a surface of a component, comprising:
disposing an ionization electrode adjacent to the surface of the component,
applying a high voltage between the ionization electrode and the surface of the component that is sufficient to generate an electric field between the ionization electrode and the surface of the component, said electric field accelerating ionized particles produced by the ionization electrode towards the surface of the component; and
causing relative movement between the ionization electrode and the surface of the component in a movement direction so as to clean the surface of the component by dislodging contaminating particles disposed on the surface of the component using the accelerated ionized particles.

16. The method according to claim 15, wherein a voltage between 1 kV and 100 kV is applied across the ionization electrode and the surface of the component.

17. The method according to claim 16, further comprising:
adjusting the high voltage such that the ions are generated through field ionization in a vicinity of the ionization electrode, but such that the vicinity does not extend to the surface.

18. The method according to claim 17, wherein the method is performed in an air environment at atmospheric pressure.

19. The method according to claim 18, wherein the component is a roller bearing element and the contaminating particles include oil.

20. A method for cleaning a surface of a component using the device of claim 1, comprising:
disposing the ionization electrode of claim 1 adjacent to the surface of the component, the ionization electrode being disposed on the movable carriage,
applying a high voltage between the ionization electrode and the surface of the component that is sufficient to generate an electric field between the ionization electrode and the surface of the component, said electric field accelerating ionized particles produced by the ionization electrode towards the surface of the component; and
moving the movable carriage relative to the surface of the component in a movement direction so as to clean the surface of the component by dislodging contaminating particles disposed on the surface of the component using the accelerated ionized particles.
